(19) United States
(12) Patent Application Publication
(10) Pub. No.: US 2022/0134626 A1
(43) Pub. Date: May 5, 2022

(54) EXTRUDER FOR THE VISCOSITY-INCREASING PREPARATION OF MELTABLE POLYMERS

(71) Applicant: Gneuss GmbH, Bad Oeynhausen (DE)

(72) Inventors: Stephan GNEUSS, Bad Oeynhausen (DE); Detlef GNEUSS, Carabietta (CH); Daniel GNEUSS, Charlotte, NC (US)

(73) Assignee: Gneuss GmbH, Bad Oeynhausen (DE)

(21) Appl. No.: 17/576,580

(22) Filed: Jan. 14, 2022

Related U.S. Application Data
(63) Continuation of application No. PCT/DE2020/100630, filed on Jul. 19, 2020.

(30) Foreign Application Priority Data
Jul. 18, 2019 (DE) 10 2019 119 533.0

(51) Int. Cl. B29C 48/76; B29C 48/52; B29C 48/53; B29B 7/84; B29B 7/42

(52) U.S. Cl. CPC B29C 48/767; B29C 48/52; B29B 7/429; B29B 7/845; B29C 48/53

(57) ABSTRACT

An extruder comprising a housing having an inner recess; in which an extruder screw having a helical extruder screw flight is rotatably mounted. The outer diameter of the extruder screw is subdivided into a diameter start region, diameter central region, and diameter end region, wherein the diameter central region has a larger outer diameter than the other diameter regions, and a conical transition is formed in each case between regions at different diameters, and wherein at least one degassing zone formed in the diameter central region said degassing zone having a housing recess from which at least one suction opening extends to an outer side of the housing. The flow channel formed between the extruder screw shaft core and the inner wall of the housing recess is an annular expansion nozzle, wherein the outer diameter of the extruder screw flight is constant and the radial flow channel height increases.

This nonprovisional application is a continuation of International Application No. PCT/DE2020/100630, which was filed on Jul. 19, 2020, and which claims priority to German Patent Application No. 10 2019 119 533.0, which was filed in Germany on Jul. 18, 2019, and which are both herein incorporated by reference.

### BACKGROUND OF THE INVENTION

### Field of the Invention

The present invention relates to an extruder for viscosity-increasing preparation of meltable polymers.

### Description of the Background Art

In plastics technology, extruders are used for plasticizing and processing polymers. If the objective is mere plasticizing, many designs are available as monorotors with one extruder screw or as twin rotors with two extruder screws, whereby the special geometry of the extruder screws results in plastic being drawn in at one end in the form of solid particles and this being melted and ejected in liquid form. In many applications, homogenization and degassing are also carried out, for example to remove moisture contained in the solids. The disadvantage here is often that the high shear stress in the extruder leads to a reduction in the molecular chain lengths in the polymer and thus to a reduction in viscosity. These effects occur particularly with high-viscosity polymers. For certain applications, however, the viscosity may not drop too much during plasticization in the extruder, as a certain viscosity of the molten polymer is required for the subsequent processing. This applies, for example, to the recycling of hydrolyzable polycondensates such as polyester (PET), and in particular in connection with demanding downstream processing operations such as the production of textile plastic fibers.

DE 2237190 A describes an extruder for processing rubber compounds which is equipped with one extruder screw. Degassing is improved by increasing the screw diameter in the suction zone, while maintaining the flight depth of the extruder screw flight compared to the feed and discharge zone to ensure a constant feed rate. An application for polymers other than rubber and for selectively influencing viscosity is not indicated.

An extruder with a multi-rotation system is known from EP 1 434 680 B1, which corresponds to US 2005/0047267, which is incorporated herein by reference, for plasticizing and, above all, for processing polymers with a simultaneous increase in viscosity. This so-called MRS extruder features an extruder screw with a multi-screw extruder section, in which several driven satellite screws are arranged around the main screw. They rotate with the extruder screw as a unit and at the same time they rotate around their own axis. In the multi-screw extruder section, there is a high degree of mixing and an increase in surface area, so that a gas extraction system arranged in this area on the extruder housing is particularly effective. Due to the efficient extraction of a large part of the moisture contained in the polymer, a significant chain elongation and thus an increase in intrinsic viscosity can be achieved in polycondensates. Since impurities are separated at the same time, an MRS extruder is particularly suitable for recycling PET and makes it possible to obtain high-purity PET directly from recycled material in continuous operation, which can be used for beverage and food packaging without further downstream treatment.

While the viscosity required for beverage and food packaging can be easily achieved with the familiar MRS extruder, the problem arises in application processes that require PET with even higher viscosity that a maximum achievable limiting viscosity is set even if various process parameters on the MRS extruder are varied. Increase and decrease in viscosity therefore always occur simultaneously, whereby the effects leading to a viscosity increase still predominate at the beginning, but then eventually balance out with the opposite effects.

### SUMMARY OF THE INVENTION

It is therefore an object of the present invention to enable the preparation of polymer melt, in particular PET, whereby a high intrinsic viscosity of at least 0.7 ml/g can be achieved.

Surprisingly, a concept leads to success that combines individual design features of the MRS extruders proven for PET processing with the familiar monorotor for rubber processing, but also adds another significant innovation.

First of all, the solution of the invention is based on a mono-rotor concept, i.e. on an extruder with only one extruder screw. According to the invention, the satellite screws present in the known MRS extruder, which have the largest share in the shearing of the polymer, are eliminated. To increase the circumferential speed in the vacuum extraction zone, a partial diameter increase of the extruder screw is provided in a degassing zone. However, the viscosity increase achievable with the extruder according to the invention is essentially due to the fact that the degassing zone is divided in two and comprises the following essential features:

In order to refer to the geometry of the extruder screw, the diameters are designated as follows:
D1 in a feeding/metering zone
D2 in a discharge zone and
D2 in the intermediate area where the degassing zone is also located.

The outer diameter of the extruder screw, which is defined by the outer edge of the extruder screw flight on the extruder screw shaft, is significantly increased compared to the preceding feed and metering zone as well as the adjoining discharge zone and is at least 1.2 to 2.0 times the diameter there. It is preferably largely constant over the length, resulting in a cylindrical envelope. This makes it easy to produce the associated bore in the housing, and small axial displacements between the extruder screw and the housing are possible. Only in the transition areas to the sections of the extruder screw before and after this a conical shape is preferred.

The outer diameter of the shaft core of the extruder screw, on the other hand, varies greatly in two sections of the degassing zone: while it is also large in an upstream initial section, resulting in a shallow flight depth between the parallel sections of the extruder screw flight, it is much smaller in the adjacent end section, resulting in deep channels.

The at least one suction opening of the housing is located where the screw flight depth is large. It can extend up to the diameter step of the shaft core between the start and end sections.

The melt, which has already been plasticized in the first part of the extruder screw, is strongly compressed in the initial area of the degassing zone, where the free volume in the flights formed between the screw flight, shaft core and barrel bore is low.

In the end region of the degassing zone, however, the volume is much larger and cannot be nearly filled by the melt that is fed in. At the diameter step of the corrugated core, therefore, an abrupt expansion of the melt into the free volume takes place. The melt stream ruptures and leads to a considerable increase in the surface area of the melt, which enables the volatile substances to be extracted from the melt.

The drive power for the extruder according to the invention is reduced compared to the prior art due to the elimination of the driven satellite screws.

If the diameter ratio D2>1.5×D1 is selected, it is ensured that an even larger area interaction between melt and vacuum is achieved in the vacuum chamber of the extruder formed by the degassing port.

It is expedient that the length of the screw in the degassing zone is 2×D2. This results in the largest possible area which can be degassed via the degassing port, so that the area on which the vacuum is effective is only insignificantly smaller than in a generic multi-screw extruder part.

If, for example, the pitch of the screw flight in the entry zone and in the degassing zone are essentially the same, it is advantageous if at least one further screw flight with essentially the same pitch is provided in the degassing zone of the screw between the screw flights.

Due to the increase in diameter in the end region of the degassing zone of the extruder, the screw flight would be considerably further apart than in the feed/metreing zone or the discharge zone of the screw, with the same pitch as in the feed and metering zone. By providing at least one further screw flight(s) located within the first screw flight, there are more shear points along the length of the screw in the degassing zone between the barrel the helixes that contribute to churning and feeding so that the surface area of the melt in the degassing zone is further increased.

However, it is also possible that, for example, the pitch of the screw in the feed/metering zone and in the discharge zone is essentially the same, but that the pitch of the screw helix in the degassing zone is greater than there.

As a result, the screw flight grows closer together in the degassing zone of the extruder. This can also result in more churning and feeding of the melt, which increases the surface area of the melt that comes into contact with the vacuum.

It is advantageous if the flight depth of the screw flight in the degassing zone is at least 10% of the diameter D2 of the screw in the degassing zone. However, it is also advantageous if the surface area of the flights formed between the screw flight(s) in the degassing zone of the screw is at least 1.5 times as large as the surface area of the channel arranged between the screw flight in the entry zone.

Each of these measures ensures that the channels between the screw flights are not fully filled with melt. In addition, the movement of the screw allows the melt to be churned in the channel. These measures also serve to ensure that a larger melt surface comes into contact with the vacuum prevailing at the degassing connections in the same time, and thus the melt can be degassed more effectively.

It can be advantageous if the extruder has an adjustable throttle or an adjustable retaining ring in the transition from the metering zone to the degassing zone, via which the shear gap can be adjusted. On the one hand, this ensures that only properly plasticized melt enters the degassing zone. On the other hand, a certain degree of sealing is achieved, which ensures that no short-circuit can occur for the negative pressure to the inlet zone.

In brief, the invention is based on the fact that the rupturing, swirling and churning of the melt in the area of the suction is not effected by mechanical mixing elements as in the prior art, but by the principle of an expansion nozzle, which in the invention is effected by the abruptly reducing core diameter with the same outer flight diameter and constant inner diameter of the housing bore in this area.

The principle of the expansion nozzle in the degassing zone according to the invention entails, in addition to the mechanical influences on the melt described, a temperature influence, namely cooling. The cooling that occurs can be used in the extruder according to the invention as an additional effect in various ways.

Whereas in the MRS extruder in the prior art, internal cooling of the extruder screw shaft in the degassing zone is almost always necessary to compensate for the enormous heat input due to mechanical shear. According to the invention this can be dispensed with at least for the end region of the degassing zone. This at least reduces the cooling power required for the entire extruder screw.

Under certain circumstances, the cooling is so severe that the melt can partially freeze. To counteract this, heating of the end area of the degassing zone can be provided. For this purpose, for example, the housing can be heated with heating bands.

Since, on the other hand, the extruder according to the invention still has a high heat input due to shear in the feed and metering zone, it is advisable to dispense with external temperature control of the extruder screw and instead to circulate a fluid for temperature control through internal channels of the screw, for which purpose only an external pump is provided, but no external heat exchanger. The fluid is introduced into an internal screw bore at the shaft end, is heated in the feed and metering zone, possibly also in the initial area of the degassing zone, and then transfers the heat in the end area to the cooled melt guided in the deep screw flights. and possibly also in the initial part of the degassing zone, and then transfers the heat in the final part to the cooled melt guided in the deep screw flights. The discharge takes place at the other end of the extruder screw shaft. The return to the pump is external.

It is advantageous if the screw has temperature control channels which, especially in the degassing zone, e.g. in the form of peripheral channels or concentric channels, ensure fast-acting, precise adjustment of the surface temperature of the screw. Even the screw flights can be formed as channels.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of an extruder from the outside;

FIG. 2 is an extruder screw in perspective view;

FIG. 3 is a detail of the extruder screw in side view;

FIG. 4 is a detail of the extruder in perspective view;

FIG. 5 is a detail of the extruder in a side, partially cut view; and

FIG. 6 is a schematic sectional view of the extruder.

### DETAILED DESCRIPTION

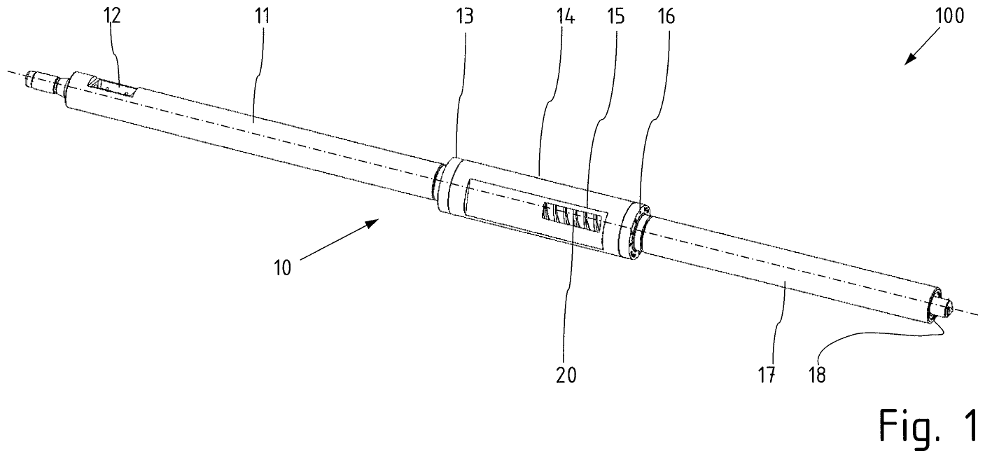

In FIG. 1, an extruder 100 according to the invention is shown in perspective view from the outside, whereby end bearing and drive elements are not shown in detail. In particular, the housing 10 with an inner housing recess 18, in which an extruder screw 20 is rotatably mounted, is visible. The housing 10 has an inlet area 11 with a feed opening 12 for solid polymer particles. Connected via a connecting flange 13 is an intermediate region 14 with an enlarged diameter, which has at least one housing opening 15 extending into the inner housing recess 18. A suction device, in particular a vacuum pump, is connected to the housing opening 15.

A further connecting flange 16 connects to an end region 17 of the housing 10, the diameter of which is again reduced and which corresponds approximately to that of the initial region 11. At the end of the end region 17, the housing recess 18, which is designed in particular as a cylindrical bore, opens so that the processed polymer melt can be discharged from this point for further processing.

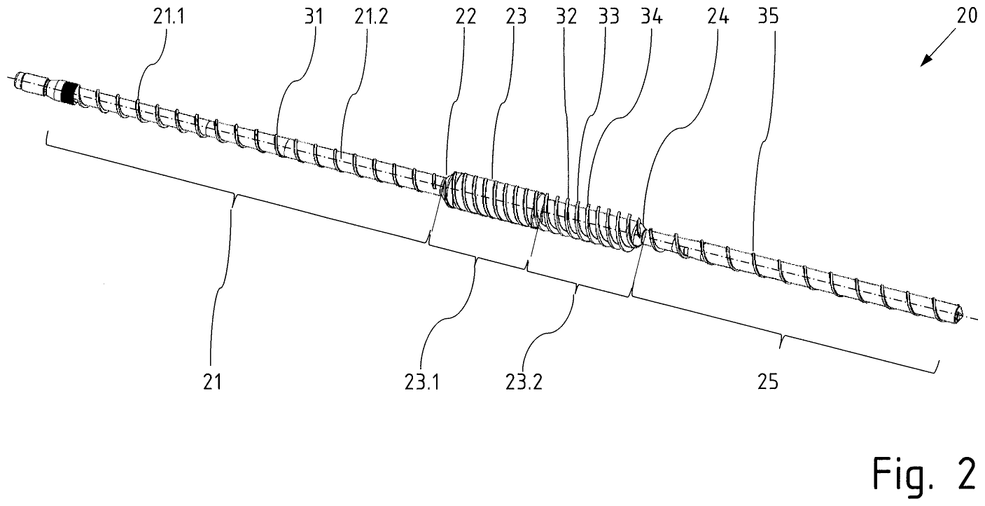

FIG. 2 shows the extruder screw 20 in perspective view. A feed zone 21.1 is used to feed the polymer as solid particles. This is followed by a metering zone 21.2. A feed zone 21.1 and a metering zone 21.2 together form an initial diameter zone 21 and have a common helical extruder screw flight 31. The extruder screw 20 has a discharge zone 25 with the same or similar diameter as the feed zone 21.1 and metering zone 21.2 and also has only one extruder screw flight 35.

Between them, in a diameter center area, there is a degassing zone 23, which in turn is divided into an initial area 23.1 and an end area 23.2. In the degassing zone 23, the screw shaft core, whose diameter varies along its length, is surrounded by a total of three intertwined extruder screw flights 32, 33, 34.

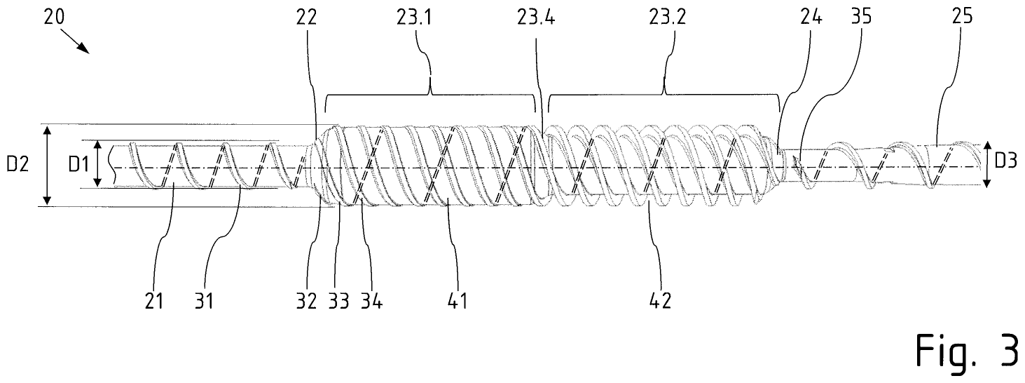

In FIG. 3, this section of the extruder screw 20 essential to the invention is shown in an enlarged, lateral view, with the respective outer diameters D1, D2, D3 also indicated. Exemplary dimensions and geometrical relations are as follows:

In the metering zone 21.2, the extruder screw flight 31 has a relatively small outer diameter D1 of 110 mm.

In the discharge zone, 25 the extruder screw flight 35 has an outer diameter D2, which is 0.8 to 1.2 times the outer diameter D1, i.e. approximately equal to D1, but may be 20% larger or smaller;

In the degassing zone 23, the extruder screw flights 32, 33, 34 have a uniform outer diameter D2 which is at least 1.5 times D2, and in particular twice as large. In the example, D2=190 mm.

The outer diameters D1, D2 and D3 thus vary only between the zones, but are constant within the respective zone 21.2, 23, 25. Tapered transition zones 22, 24 are formed in between.

The shaft core diameter is largely constant in both the metering zone 21.2 and the discharge zone 25. Small variations in the shaft core diameter and/or the pitch of the screw are provided, as is usual in extrusion technology, in order to achieve homogenization and compaction and/or to influence the flow rate locally.

Immediately in the transition from the degassing zone 23 to the discharge zone 25, the shaft core diameter of the discharge zone 25 is reduced, for example, compared to the diameter in the further course, so that the melt pressure can be built up again in the discharge zone after it was at approximately zero in the degassing zone due to the vacuum present there.

It is essential to the invention that the shaft core diameter within the degassing zone 23 is abruptly reduced at a transition point 23.4. While in the initial section 23.1 of the degassing zone 23 the shaft core diameter is large and the height of the extruder screw flights 32, 33, 34 and thus the height of the flights 41 formed therebetween is small, the shaft core diameter in the end section 23.2 is considerably smaller. In the example given, in the case of the flights 41 in the initial section 23.1 the flight depth is 4 mm, in particular between 10% and 20% of the outer diameter D2. In the end section 23.2 in the case of the flights 42, the flight depth is 32 mm, so that the height of the flights 42 there has increased by a factor of 3 to 10 compared with the flights 41 in the initial section 23.1.

The dashed double lines in FIG. 3 serve to indicate the course of the extruder screw flights. In the metering zone 21.2 and the discharge zone 25, there is only one helical extruder screw flight 31, 35 in each case. In the degassing zone 23, the dashed double lines indicate only the course of a first extruder screw flight 32. It can be clearly seen that these lines cross two further extruder screw flights 33, 34 in each case. Thus, a total of three intertwined extruder screw flights 32, 33, 34 are formed in the degassing zone 23.

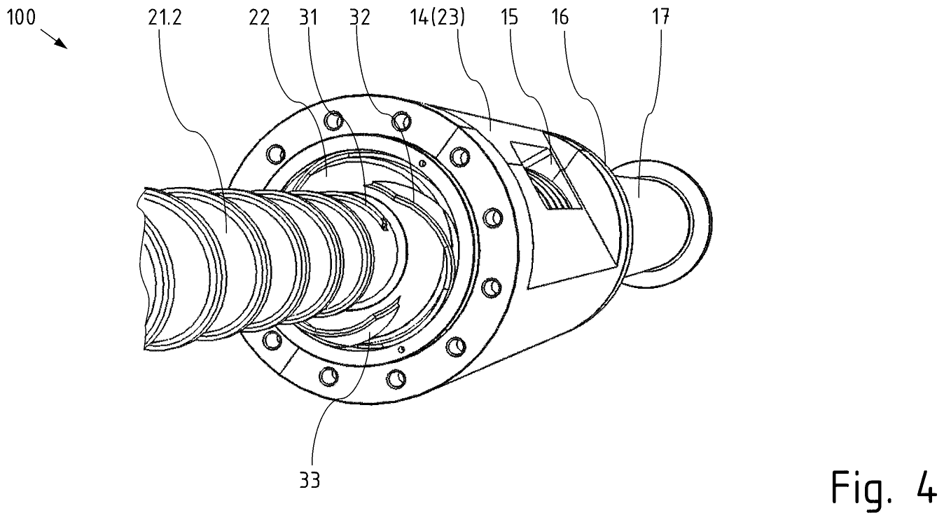

FIG. 4 shows a perspective view of the transition from the metering zone 21.2 to the degassing zone 23. For this purpose, the housing parts 11 and 13 (see FIG. 1) are removed so that there is a clear view of the conical transition zone 22. The extruder screw flight 31 of the metering zone 21.2 runs out in front of the transition zone 22. Already within the transition zone 22, the three extruder screw flights of the degassing zone 23 have their beginning, whereby in FIG. 4 only the beginnings of the extruder screw flights 32, 33 are visible. The termination of extruder screw flight 31 before the transition zone 22 and the start of the three extruder screw flights 32, 33 and 34 in the transition zone 22 result in an early division of the melt stream into three partial streams.

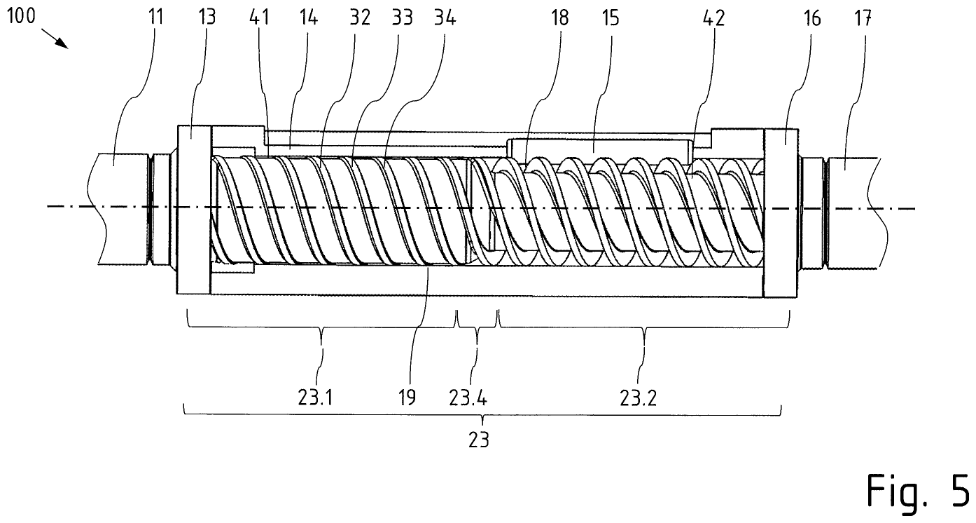

FIG. 5 shows the essential part of the extruder 100 according to the invention in a partially cut view. Herein, the intermediate region 14 of the housing 10 is shown in section. This shows, on the one hand, that the inner wall 19 of the housing recess runs completely rectilinearly in section, that is, that the housing bore is cylindrical, with the exception of the interruption at the suction opening 15. Furthermore, it can be seen that the outer edges of all three extruder screw flights 32, 33, 34 always end very close in front of the inner wall 19. In the initial area 23.1, very narrow passages 41 are formed through which the entire melt flow must be conveyed. Finally, FIG. 5 clearly shows the course of the diameter of the extruder shaft core, which is abruptly reduced at the transition point 23.4 and then remains constantly small in the end region 23.2. As a result, large-volume passages 42 are formed between the inner wall 19, the parallel sections of the extruder screw flights 32, 33, 34 and the extruder shaft core.

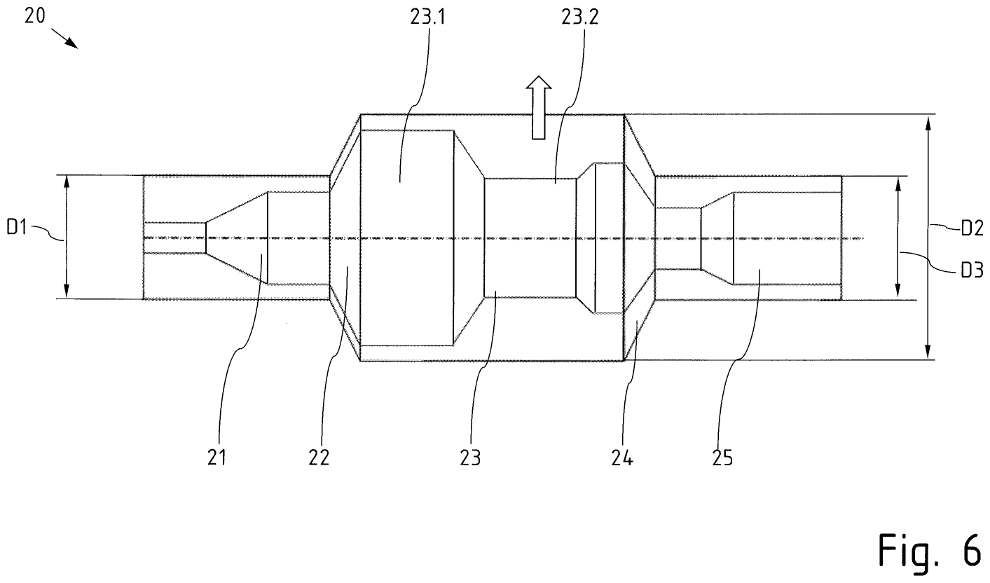

FIG. 6 is a schematic, highly exaggerated representation of the dimensional relationships on the extruder screw 20. Showing the shaft core diameter and the outer diameter measured over the outer edges of the flights. Through this representation, the variation of the flight depth over the length of the extruder screw 20 in particular becomes clear. Towards the end of the metering zone 21, the shaft core diameter increases. The outer diameter D1 remains constant. This reduces the flight depth. Compression of the conveyed melt occurs. In the transition zone 22, the flowable volume expands because the outside diameter increases to D2. This is compensated for by a further reduction in the passage depth in the conical transition zone 22. The aim is to convey the melt to the initial region 23.1 in such a way that the flow channels are filled. The narrow gap there also increases shear.

In the middle of the degassing zone 23, the corrugation core diameter is abruptly reduced significantly, while the outer diameter D2 of the flights remains constant. The volume of the flow channel created there can no longer be filled by the melt fed in via the initial zone 23.1. This results in a sudden expansion of the previously highly sheared and thus also highly heated melt. During the expansion, the volatile substances contained dissolve particularly well and can be extracted, as indicated by the block arrow.

This is followed by a multiple flow channel narrowing to collect the melt gas-free again and convey it homogeneously. To this end, the flow channel initially tapers slightly towards transition zone 24. In transition zone 24, the flights and the corrugated core each have a different cone angle, which also causes a flow channel enlargement. Between the transition zone 24 and the beginning of the discharge zone 25, a short constant channel depth is provided before the shaft core diameter increases again and the channel depth is consequently reduced while the outer diameter D2 of the extruder screw flights remains constant.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An extruder for viscosity-increasing processing of meltable polymers, the extruder comprising:
an extruder screw with at least one helical extruder screw flight, the extruder screw being subdivided with respect to its outer diameter into a diameter start region, a diameter middle region and a diameter end region, the diameter middle region having a larger outer diameter than the diameter start or end regions;
a housing with an inner housing bore, in which the extruder screw is rotatably arranged;
a transition cone formed between diameter regions of different diameters; and
at least one degassing zone formed in the diameter middle region, which has a housing recess from which at least one suction opening extends towards an outer side of the housing,
wherein the extruder screw is formed in the diameter middle region such that a flow channel formed between an extruder screw shaft core and an inner wall of the housing recess is designed as an annular expansion nozzle, the outer diameter of the at least one extruder screw flight being constant and the radial flow channel height widening, and
wherein the at least one suction opening is arranged in the end section at the end of the degassing zone.

2. The extruder of claim 1, wherein the extruder screw is functionally divided into at least a metering zone, a devolatilization zone, and a discharge zone (25), wherein a compressor for compressing and/or homogenizing the polymer melt are formed on the extruder screw in the metering zone, wherein the metering zone, viewed in a direction of flow, extends from the diameter start region over the transition cone into the diameter center region, and wherein the discharge zone is completely formed in the diameter end region.

3. The extruder of claim 1, wherein the extruder screw flight has an outer diameter n the diameter center region which corresponds to at least 1.5 times the diameter in the diameter start region.

4. The extruder of claim 1, wherein the diameter center region has an initial region and an end region, and wherein the radial flight depth of the flights formed between adjacent portions of the at least one extruder screw flight is smaller in the initial region than in the end region.

5. The extruder of claim 1, wherein the flight depth of the extruder screw flights in the end region of the diameter center region is at least three times the flight depth of the initial region.

6. The extruder of claim 1, wherein the flight depth of the at least one extruder screw flight in the initial region of the degassing zone is 1% to 5% of the diameter.

7. The extruder of claim 1, wherein the flight depth of the at least one extruder screw flight in the end region is at least 10% of the diameter in the degassing zone.

8. The extruder of claim 1, wherein the flight depth of the at least one extruder screw flight in the end region is at least 20 mmm.

9. The extruder of claim 1, wherein the diameter is at least equal to a multiple of D1.1,5.

10. The extruder of claim 1, wherein the length of the degassing zone is at least 2.0 times D2.

11. The extruder of claim 1, wherein the extruder screw at the transition from the metering zone to the initial section and/or at the transition from the end section to the discharge zone respectively has a conical transition zone in which the extruder screw flight is interrupted.

12. The extruder of claim 1, wherein at least in the degassing zone at least two intertwined extruder screw flights with the same pitch are formed on the extruder screw.
